(19) United States
(12) Patent Application Publication
(10) Pub. No.: US 2004/0031186 A1
(43) Pub. Date: Feb. 19, 2004

(54) Fishing bait

(76) Inventors: Felix H. Soldan, Oberfurberg (DE); Johann Rower, Furth (DE)

Correspondence Address: BROWDY AND NEIMARK, P.L.L.C., 624 NINTH STREET, NW, SUITE 300, WASHINGTON, DC, 20001-5303, US

(21) Appl. No.: 10/275,291

(22) PCT Filed: Apr. 28, 2001
(86) PCT No.: PCT/EP01/04799

(30) Foreign Application Priority Data
May 4, 2000 (DE) 200-08-052.0

(51) Int. Cl. A01K 85/00

(52) U.S. Cl. 43/42.19

(57) ABSTRACT

In a fishing lure in the form of a troll, in particular for fishing swordfish or the like, it is provided, with a view to improved efficiency, that a plurality of very fine plastic fibers are fixed to the lure.

The invention relates to a fishing lure in the form of a troll, in particular for fishing swordfish or the like.

Trolls of the generic type, which are also called rigs, are used in deep sea fishing. They are drawn through the water from the boat, this motion appearing as the motion of prey, in particular of bonitos, attracting swordfish. Familiar rigs of the species comprise a basic body of plastic material, glass or metal with one or several hooks attached thereto which may be covered by wide plastic fibers.

Since a swordfish usually hits a prey with his sword to stun the prey, hooks do not really work, there being little probability that the swordfish gets hooked when hitting these familiar lures.

It is an object of the invention to improve the efficiency of known lures.

According to the invention, this object is attained in that a plurality of very thin plastic fibers, preferably polyamide fibers, of a thickness of only 15 to 20 μm are fixed to the lure.

When a swordfish touches these fibers, his sword gets caught in the fibers which hold it reliably, there being no need of hooks.

In keeping with the invention, provision is made for frontal inlets which are followed by passages that are elbowed sidewards. As the troll moves, water flows from the front through these passages, the elbowed design of which confers a pulse on the troll before the water flows out again so that the lure will make a dancing motion similar to prey, which attracts the swordfish that is to be caught.

In keeping with another embodiment of the invention, a borehole may be provided in the basic body of the lure, including balls that can move within the borehole as the troll moves. This produces a noise, which is a highly efficient additional bait.

By advantage, dummy eyes are applied laterally to the basic body of the troll, making it even more realistic.

For increased attraction, reflecting mica film may be glued on the lure. The fibers can be adapted to the colors of prey fish, depending on the respective environment. This also applies to the design of the heads. It is conceivable to copy bonitos by adding two spots behind the eyes.

For ease of replacement and adaptability, the head can be designed as a screw-on part. As a result, it will be possible not only to use fiber bundles that differ in color, but worn and bleached bundles can easily be replaced. As regards the material of the fibers, variations are possible just as well; for example, a bundle may consist of silk fibers in its entirety or in part.

The diameter of the lure can also be suited to the purpose and the size of the fish to be caught.

In keeping with another especially advantageous embodiment, provision is made for a battery with a set of flashing signals to be incorporated in the lure, the electric circuit being closed via electronics upon contact with water so that a flashing effect is obtained for fishing at dawn and at dusk.

Details of the invention will become apparent from the ensuing description of a preferred exemplary embodiment, taken in conjunction with the drawing, in which

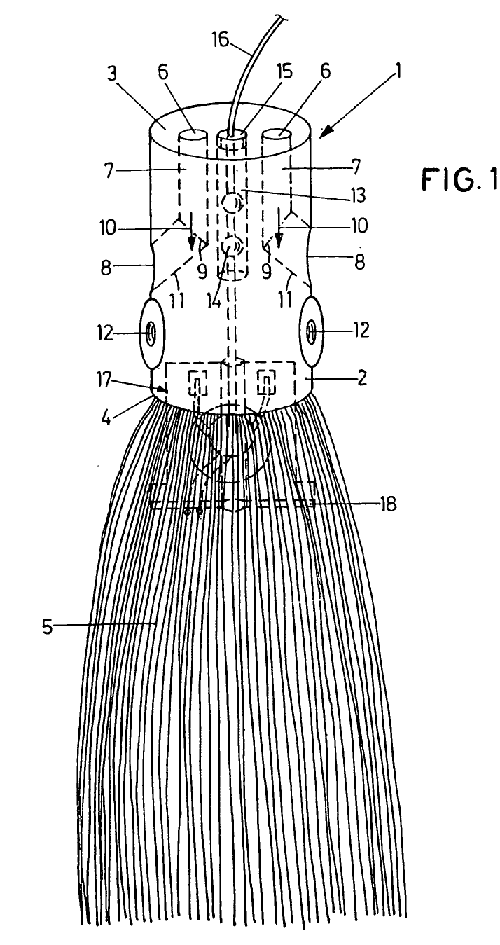

FIG. 1 is a diagrammatic lateral view of a lure according to the invention; and

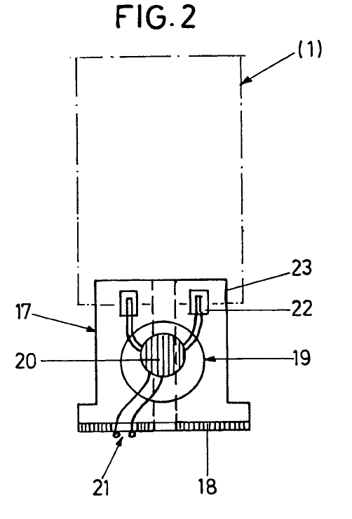

FIG. 2 is a diagrammatic illustration of the electronic insert.

Mounted on an annular groove 4 of the basic body 2 are a plurality of polyamide fibers 5 of a diameter of 15 to 20 μm which a swordfish becomes adhered to when touching the lure.

The front 3 of the basic body 2 is provided with two inlets 6 with passages 7 mouthing therein which have lateral outlets 8. The passages 7 have an elbow 9, as a result of which any water that enters in the direction of the arrows 10 hits the side wall 11 of the passages 7, conferring a pulse on the basic body 2 that will incite the lure 1 to make a dancing motion.

Dummy eyes 12 are provided laterally below the outlets 8.

Furthermore, the basic body has a central longitudinal borehole 13 with metal balls 14 inserted therein with play; as the lure 1 moves, they can roll back and forth, hitting on the inside wall of the borehole 13 and producing a noise. At the font 3, the longitudinal borehole 13 is closed by a cap 15 with a trolling line attached thereto. The cap 15 may be a screw cap with a hook for attachment of the line.

As roughly outlined by dashed lines in FIG. 1, an electronic insert 17 may be screwed into the lure from the side of the polyamide fibers 5. As seen in FIG. 2, this insert is covered by a steel disk 18, inwardly enclosing electronics 19. The electronics 19 are fed by a long-lasting battery 20. Insulated contacts 21 pass through the steel disk 18 and are connected to the electronics 19. Via transistor circuit and by conductivity of the sea water when the lure is dropped into the sea, the battery becomes connected and is put to the inputs of two bulbs 22 which are triggered intermittently so that they flash.

The electronic insert 17 has an external thread 23 which to screw into a threaded borehole of the lure 1.

1. A fishing lure in the form of a troll, in particular for fishing swordfish or the like, characterized in that a plurality of very thin plastic fibers are attached to the lure.

2. A fishing lure according to claim 1, characterized in that the plastic fibers consist of polyamide.

3. A fishing lure according to claim 1 or 2, characterized in that the fibers have a thickness of 15 to 20 μm.

4. A fishing lure according to claim 1, characterized in that inlets (6) are provided frontally, which are adjoined by laterally elbowed passages (7).

5. A fishing lure according to claim 1, characterized in that at least one borehole (13) is provided in the basic body (2), with balls (14) inserted therein which are movable in the borehole (13).

6. A fishing lure according to claim 1, characterized in that dummy eyes (12) are applied laterally to the basic body (2).

7. A fishing lure according to claim 1, characterized in that an electronic arrangement is provided which comprises flashing signals so that flashing bulbs are triggered when the lure is dropped into the water.
